(19) United States
(12) Patent Application Publication
(10) Pub. No.: US 2016/0028309 A1
(43) Pub. Date: Jan. 28, 2016

(54) POWER SOURCE CIRCUIT

(71) Applicant: KABUSHIKI KAISHA TOSHIBA, Tokyo (JP)

(72) Inventor: Takayuki MIYAZAKI, Setagaya Tokyo (JP)

(21) Appl. No.: 14/636,001

(22) Filed: Mar. 2, 2015

(30) Foreign Application Priority Data
Jul. 24, 2014 (JP) 2014-150976

(51) Int. Cl. H02M 3/158

(52) U.S. Cl. CPC H02M 3/158

(57) ABSTRACT

A power source circuit includes a first power source terminal, and a second power source terminal, an output terminal, a first switching transistor that is connected between the first power source terminal and the output terminal, a comparator that compares a feedback voltage of the output voltage with a predetermined reference voltage, a pulse forming circuit that forms a pulse signal having a predetermined width in accordance with an output from the comparator, a timing adjustment circuit that outputs a control signal for the first switching transistor according to a pulse width of the pulse signal, and a frequency-locked loop (FLL) circuit, which controls the pulse width of the pulse signal of the pulse forming circuit in accordance with a frequency of the reference frequency signal and a frequency of the pulse signal.

### CROSS-REFERENCE TO RELATED APPLICATION

This application is based upon and claims the benefit of priority from Japanese Patent Application No. 2014-150976, filed Jul. 24, 2014, the entire contents of which are incorporated herein by reference.

### FIELD

Embodiments described herein relate generally to a power source circuit.

### BACKGROUND

A power source circuit which performs a so-cold Constant-ON time control is known in the art. According to this technique, a reference voltage and an output voltage are compared to each other, and when the output voltage becomes lower than the reference voltage, a drive signal having a fixed pulse width is supplied to a switching transistor so as to turn on the switching transistor to cause the output voltage to become equal to the reference voltage.

The Constant-ON time control has an advantage that power conversion efficiency is favorable in the case of a light load. However, switching frequency at which the switching transistor is turned on or off is not fixed and hence, and an RF (Radio Frequency) signal may interfere with a drive signal such as when an RF circuit is disposed near the power source circuit.

### DESCRIPTION OF THE DRAWINGS

FIG. 1 is a view illustrating a power source circuit according to a first embodiment.

FIG. 2 is a view illustrating one example of a frequency-locked loop circuit.

FIG. 3 is a view illustrating one example of a pulse width adjustment circuit.

FIG. 4 is a flow diagram illustrating one example of control steps of pulse width adjustment.

FIG. 5 is a flow diagram illustrating another example of the control steps of pulse width adjustment.

### DETAILED DESCRIPTION

Embodiments provide a power source circuit which may control switching frequency.

In general, according to one embodiment, a power source circuit includes a first power source terminal to which a DC input voltage is applied, and a second power source terminal to which a reference voltage is applied, an output terminal to which an output voltage is supplied, a first switching transistor that is connected between the first power source terminal and the output terminal, a comparator that compares a feedback voltage of the output voltage with a predetermined reference voltage, a pulse forming circuit that forms a pulse signal having a predetermined width in accordance with an output from the comparator, a timing adjustment circuit that outputs a control signal for the first switching transistor according to a pulse width of the pulse signal, and a frequency-locked loop circuit that controls the pulse width of the pulse signal of the pulse forming circuit in accordance with a frequency of the reference frequency signal and a frequency of the pulse signal.

Hereinafter, the power source circuits according to the embodiments are explained in detail with reference to the attached drawings. However, the present disclosure is not limited by these embodiments.

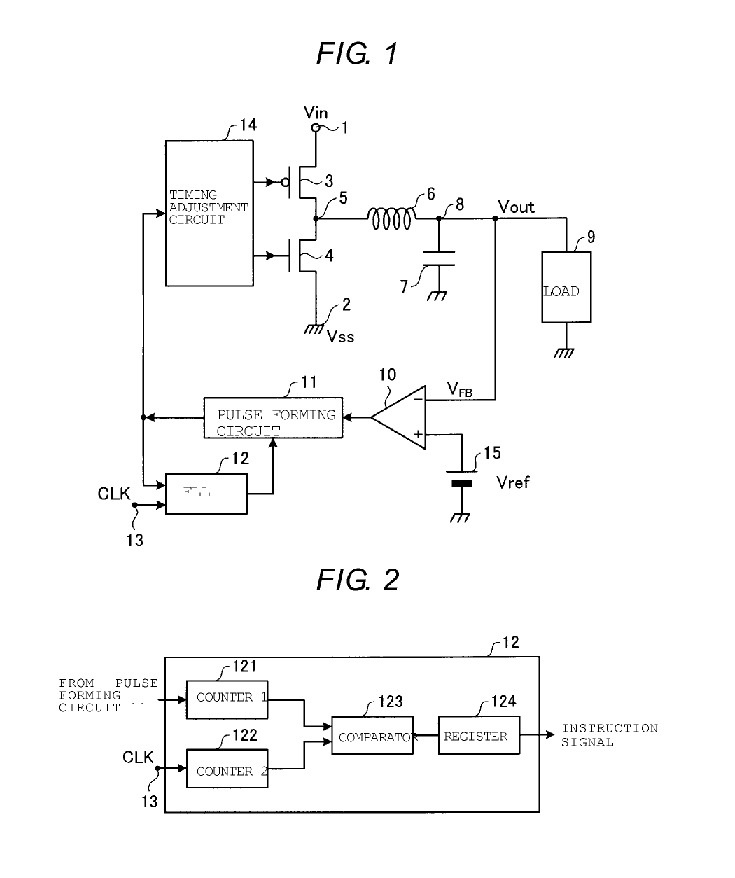

FIG. 1 illustrates the power source circuit of an embodiment. In this embodiment, the power source circuit includes a first power source terminal 1 and a second power source terminal 2. A DC input voltage Vin is applied to the first power source terminal 1, and a ground potential Vss which becomes a reference voltage is supplied to the second power source terminal 2. A source electrode of a high side switching transistor 3 is connected to the first power source terminal 1. A drain electrode of the high side switching transistor 3 is connected to an output node 5. That is, a source-drain path which is a main current path of the high side switching transistor 3 is connected between the first power source terminal 1 and the output node 5.

A drain electrode of a low side switching transistor 4 is connected to the output node 5. A source electrode of the low side switching transistor 4 is connected to the second power source terminal 2. That is, a source-drain path which is a main current path of the low side switching transistor 4 is connected between the output node 5 and the second power source terminal 2.

An inductor 6 is connected between the output node 5 and an output terminal 8. One end of a smoothing capacitor 7 is connected to the output terminal 8, and the other end of the smoothing capacitor 7 is connected to a ground. An output voltage Vout is outputted from the output terminal 8, and is supplied to a load 9.

A feedback voltage V_{FB} of the output voltage Vout is supplied to an inverted input terminal of a comparator 10. The feedback voltage V_{FB} may also be a voltage obtained by dividing the output voltage Vout. A reference voltage source 15 is connected to a non-inverted input terminal of the comparator 10, and a reference voltage Vref is applied to the comparator 10. In the comparator 10, the feedback voltage V_{FB} and the reference voltage Vref are compared to each other, and an output signal based on a result of such a comparison is supplied to a pulse forming circuit 11.

The pulse forming circuit 11 forms a pulse signal having a predetermined width in response to an output signal supplied from the comparator 10 when a feedback voltage V_{FB} becomes lower than a reference voltage Vref, and outputs the pulse signal. An output signal of the pulse forming circuit 11 is supplied to a timing adjustment circuit 14 and a frequency-locked loop (FLL) circuit 12.

A clock signal CLK which becomes reference frequency for operating the power source circuit is supplied to a clock input terminal 13. A pulse signal of the pulse forming circuit 11 and a clock signal CLK are supplied to the FLL circuit 12. The FLL circuit 12 performs a control of adjusting a pulse width of a pulse signal of the pulse forming circuit 11 corresponding to frequency of a pulse signal of the pulse forming circuit 11 and frequency of a clock signal CLK. For example, the FLL circuit 12 counts and compares frequency of a clock signal CLK and frequency of a pulse signal of the pulse forming circuit 11 with each other for a predetermined time, and performs a control of increasing a pulse width of the pulse signal when the frequency of the pulse signal of the pulse forming circuit 11 is higher than the frequency of the clock signal CLK. That is, the FLL circuit 12 performs a control of extending an ON time of the high side switching transistor 3 by increasing a pulse width of a pulse signal. Due to such a control, an output voltage Vout is increased, and the number of times that a feedback voltage V_{FB} of the output voltage Vout becomes lower than a reference voltage Vref is decreased. That is, the FLL circuit 12 performs a control where frequency of a pulse signal output by the pulse forming circuit 11 is lowered.

On the other hand, when frequency of a pulse signal of the pulse forming circuit 11 is lower than frequency of a clock signal CLK, the FLL circuit 12 performs a control of decreasing a pulse width of the pulse signal. That is, the FLL circuit 12 performs a control of shortening an ON time of the high side switching transistor 3 by decreasing the pulse width of the pulse signal. Due to such a control, an output voltage Vout is lowered, and the number of times that a feedback voltage V_{FB} of the output voltage Vout becomes lower than a reference voltage Vref is increased. That is, the FLL circuit 12 performs a control of increasing the frequency of a pulse signal output by the pulse forming circuit 11. The FLL circuit 12 may perform the frequency control of a pulse signal by adjusting a pulse width of the pulse signal formed by the pulse forming circuit 11.

A pulse signal formed by the pulse forming circuit 11 is supplied to the timing adjustment circuit 14. The timing adjustment circuit 14 generates a drive signal in response to the pulse signal from the pulse forming circuit 11, and supplies the drive signal to a gate electrode of the high side switching transistor 3 and a gate electrode of the low side switching transistor 4. The timing adjustment circuit 14 supplies a drive signal to the gate electrode of the high side switching transistor 3 and the gate electrode of the low side switching transistor 4 by performing the timing adjustment where a dead time is provided for preventing the high side switching transistor 3 and the low side switching transistor 4 from being simultaneously turned on. Turning on or off the low side switching transistor 4 is complementarily controlled with respect to the high side switching transistor 3 based on a drive signal from the timing adjustment circuit 14.

According to this embodiment, frequency of a clock signal CLK and frequency of a pulse signal which the pulse forming circuit 11 outputs are compared to each other, and a pulse width of the pulse signal is adjusted corresponding to a result of such a comparison. Frequency of a pulse signal formed by the pulse forming circuit 11 may be controlled by the adjustment of a pulse width of a pulse signal and hence, switching frequency of the power source circuit may be controlled by the adjustment of the pulse width of the pulse signal. As a result, it is possible to provide a power source circuit which may perform a control of making switching frequency coincide with frequency of a clock signal CLK. Accordingly, it is possible to provide the power source circuit having the configuration which may avoid interference with an RF signal. Further, frequency of a clock signal CLK and frequency of a pulse signal of the pulse forming circuit 11 are counted, and a digital control is performed based on a result of counting and hence, it is possible to provide a frequency control with high accuracy.

FIG. 2 is a view illustrating one example of the FLL circuit 12. The FLL circuit 12 includes a first counter 121 and a second counter 122. A pulse signal of a pulse forming circuit 11 is supplied to the first counter 121. That is, the first counter 121 counts frequency of the pulse signal formed by the pulse forming circuit 11. A clock signal CLK is supplied to the second counter 122. That is, the second counter 122 counts frequency of the clock signal CLK. The first counter 121 and the second counter 122 are connected to a comparator 123. A count value of frequency of a pulse signal within a predetermined time and a count value of frequency of a clock signal CLK within a predetermined time are respectively supplied to the comparator 123 from the first counter 121 and the second counter 122, and the magnitudes of the respective count values are compared to each other.

An output of the comparator 123 is supplied to a register 124. The register 124 stores an instruction value for controlling a pulse width of a pulse signal, for example. The instruction value of the register 124 is changed corresponding to an output signal from the comparator 123, that is, the relationship of the count values in the first counter 121 and the second counter 122. An output signal of the register 124 is supplied to the pulse forming circuit 11 as an instruction signal for controlling a pulse width of a pulse signal.

For example, when a count value counted by the first counter 121 is large, that is, when frequency of a pulse signal formed by the pulse forming circuit 11 is higher than frequency of a clock signal CLK, an instruction value of the register 124 is set to “+1”, that is, the instruction value of the register 124 is changed to an instruction value of a control for increasing a pulse width of a pulse signal. An output signal of the register 124 is supplied to a pulse forming circuit 11 as an instruction signal of a control for increasing a pulse width of a pulse signal.

On the other hand, when frequency of a pulse signal formed by the pulse forming circuit 11 is lower than frequency of a clock signal CLK, an instruction value of the register 124 is set to “−1”, that is, the instruction value of the register 124 is changed to an instruction value of a control for decreasing a pulse width of a pulse signal. That is, by changing the instruction value of the register 124 by “1” each time an operation of comparing frequency of a pulse signal and frequency of a clock signal CLK is performed, the FLL circuit 12 performs a control of adjusting a pulse width of the pulse signal according to a preliminarily set width. Frequency of the pulse signal is not largely changed due to such a control and hence, the FLL circuit 12 may perform a stable frequency control of the pulse signal.

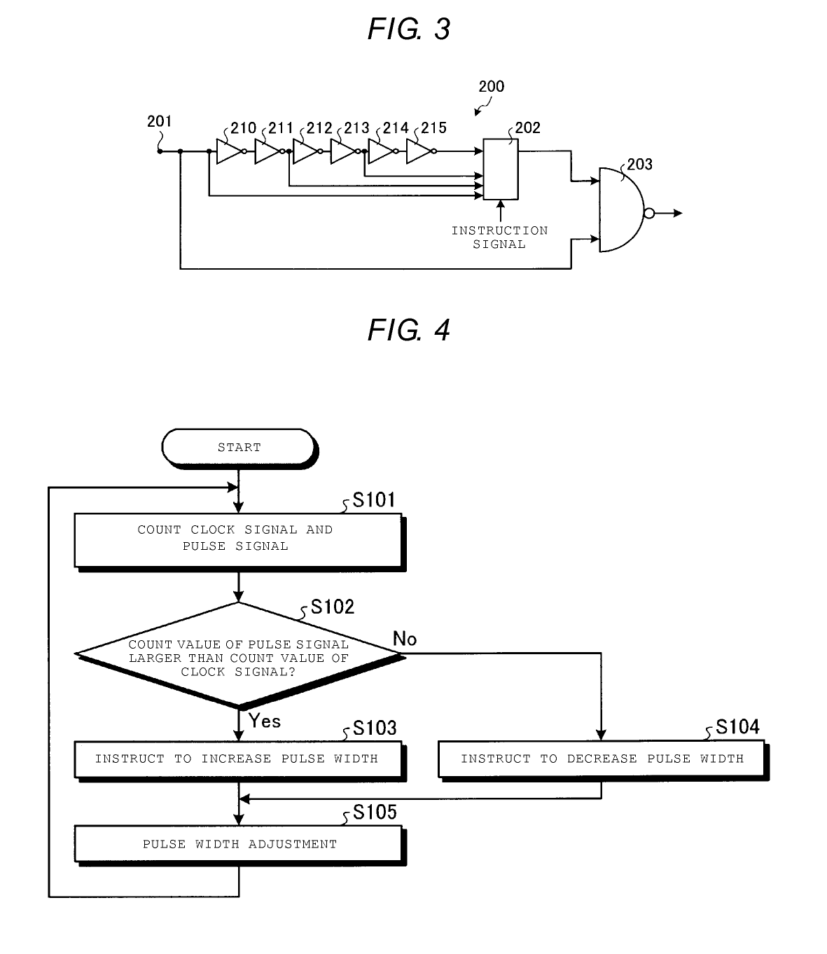

FIG. 3 is a view illustrating one example of a pulse width adjustment circuit 200. The pulse width adjustment circuit 200 is provided in a pulse forming circuit 11. The pulse width adjustment circuit 200 receives an output signal of a pulse generating circuit (not illustrated in the drawing) which outputs a pulse having a fixed pulse width in response to a signal of a comparator 10. The pulse generating circuit may include a single stable multivibrator which generates a pulse having a fixed pulse width in response to an output signal of the comparator 10, for example.

The pulse width adjustment circuit 200 includes a plurality of inverters (210 to 215) connected in series. The inverters (210 to 215) form a delay line. An output of every one other inverter (210 to 215) is supplied to a selection circuit 202. An instruction signal from a FLL circuit 12 is supplied to the selection circuit 202, and a signal to be supplied to a NAND circuit 203 is selected in response to the instruction signal. That is, a delay time of a signal to be supplied to the NAND circuit 203 is adjusted in response to an instruction signal. A signal supplied to an input terminal 201 is directly inputted to the other input terminal of the NAND circuit 203.

The NAND circuit 203 outputs a signal at an L level when the level of a signal supplied to both input terminals is at an H level. A delay time of a signal to be supplied to one input terminal of the NAND circuit 203 is adjusted depending on an output of the inverter (210 to 215) which the selection circuit 202 selects. A pulse width of a signal at an L level in the NAND circuit 203 may be adjusted by adjusting the delay time. For example, when it is necessary to increase the pulse width of the signal at an L level in the NAND circuit 203, a control is performed so as to supply a signal from a front stage side of the inverters (210 to 215) to the NAND circuit 203 for reducing a delay time. A pulse signal whose pulse width is adjusted is supplied to the timing adjustment circuit 14.

FIG. 4 is a flow diagram illustrating one example of control steps of the pulse width adjustment. The control steps of this embodiment are an example of a control where a pulse width of a pulse signal formed by the pulse forming circuit 11 is adjusted by comparing magnitude of frequency of a clock signal CLK and magnitude of frequency of a pulse signal in the pulse forming circuit 11.

Frequency of a clock signal CLK and frequency of a pulse signal in the pulse forming circuit 11 are counted for a predetermined time (S101). Magnitude of the count value of the frequency of the clock signal CLK for the predetermined time and magnitude of the count value of the frequency of the pulse signal for the predetermined time are compared to each other (S102). When the count value of the frequency of the pulse signal is higher than the count value of the frequency of the clock signal CLK, that is, when the frequency of the pulse signal is higher than the frequency of the clock signal CLK, an instruction of increasing a pulse width of the pulse signal is made (S103).

When the count value of the frequency of the pulse signal is smaller than the count value of the frequency of the clock signal CLK, that is, when the frequency of the pulse signal is lower than the frequency of the clock signal CLK, an instruction of decreasing a pulse width of a pulse signal in the pulse forming circuit 11 is made (S104).

The adjustment of a pulse width is performed in response to an instruction signal (S105). An ON time of a high side switching transistor 3 is extended by increasing the pulse width and hence, an output voltage Vout may be increased. Accordingly, the number of times that a feedback voltage V_{FB} of an output voltage Vout becomes lower than a reference voltage Vref may be decreased and hence, frequency of the pulse signal maybe lowered. On the other hand, an ON time of the high side switching transistor 3 becomes short by decreasing a pulse width of a pulse signal and hence, an output voltage Vout may be lowered. Accordingly, the number of times that a feedback voltage V_{FB} of an output voltage Vout becomes lower than a reference voltage Vref may be increased and hence, frequency of the pulse signal may be increased. After a lapse of a predetermined period, a count value of a first counter 121 and a count value of a second counter 122 are reset, and similar steps are repeated. Due to such series of control steps, it is possible to perform a control by which switching frequency of a power source circuit is made to coincide with frequency of a clock signal CLK.

Magnitude of frequency of a clock signal CLK and magnitude of frequency of a pulse signal of the pulse forming circuit 11 are compared to each other, and a pulse width of a pulse signal is adjusted corresponding to a result of the comparison thus performing a control by which switching frequency of the power source circuit is made to coincide with frequency of a clock signal CLK. Accordingly, switching frequency of the power source circuit may be set to a value which does not interfere with a nearby RF signal due to frequency of a clock signal CLK.

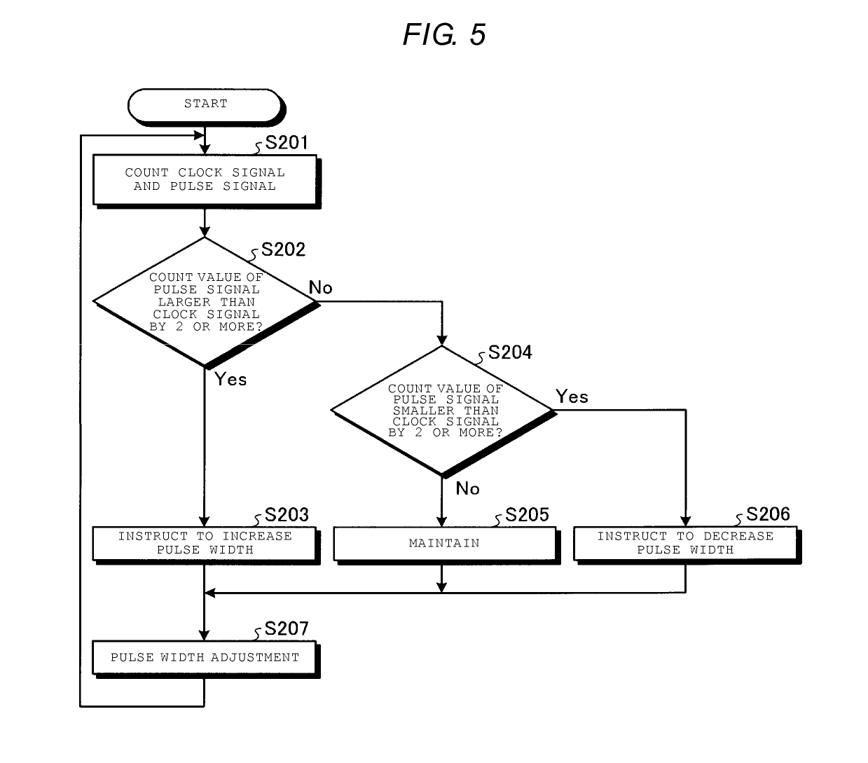

FIG. 5 is a flow diagram illustrating another example of the control steps of the pulse width adjustment. In this example, a pulse width of a pulse signal formed by a pulse forming circuit 11 is adjusted based on the difference between frequency of a clock signal CLK and frequency of a pulse signal of the pulse forming circuit 11.

Frequency of a clock signal CLK and frequency of a pulse signal formed by the pulse forming circuit 11 are counted for a predetermined time (S201). A count value of the frequency of the clock signal CLK and a count value of the frequency of the pulse signal are compared to each other, and it is determined whether or not the difference in count value is larger than a predetermined value, for example, by 2 or more (S202). When the count value of the frequency of the pulse signal is larger than the count value of the clock signal CLK by 2 or more, that is, when the frequency of the pulse signal is higher than the frequency of the clock signal CLK, an instruction is made so as to increase a pulse width of the pulse signal (S203).

When the count value of the frequency of the pulse signal is not larger than the count value of the frequency of the clock signal by 2 or more, it is determined whether or not the count value of the pulse signal is smaller than the count value of the frequency of the clock signal by 2 or more (S204). When the count value of the frequency of the pulse signal is not smaller than the count value of the frequency of the clock signal by 2 or more, an instruction is made so as to maintain a pulse width of the pulse signal (S205). When the count value of the frequency of the pulse signal is smaller than the count value of the frequency of the clock signal by 2 or more, an instruction is made so as to decrease the pulse width of the pulse signal (S206).

The adjustment of a pulse width is performed in response to an instruction signal (S207). That is, during the adjustment for increasing a pulse width of a pulse signal, a control is performed such that an ON time of a high side switching transistor 3 is extended so as to increase an output voltage Vout so that the number of times that a feedback voltage V_{FB} of the output voltage Vout becomes lower than a reference voltage Vref is decreased, whereby switching frequency is lowered. On the other hand, during performing the adjustment for decreasing a pulse width of a pulse signal, a control is performed such that an ON time of the high side switching transistor 3 is shortened so as to lower an output voltage Vout so that the number of times that a feedback voltage V_{FB} of the output voltage Vout becomes lower than a reference voltage Vref is increased, whereby switching frequency is increased. When a predetermined period elapses, counters are reset, and similar steps are repeated. Accordingly, it is possible to provide a power source circuit which may control switching frequency using a clock signal CLK.

In the control steps of the pulse width adjustment in this example, when the difference between frequency of a pulse signal and frequency of a clock signal CLK is smaller than a predetermined value, for example, “2” or less, the adjustment of a pulse width of the pulse signal is not performed. That is, it is possible to provide a configuration where frequency control is not performed part of the time. Accordingly, it is possible to provide a power source circuit with a small change in frequency. For example, the power source circuit may be configured such that an arithmetic operation circuit (not illustrated in the drawing) is provided in FLL circuit 12, the difference between a counter value of a first counter 121 and a counter value of a second counter 122 is calculated, and a result of the calculation is compared with a predetermined value, for example, “2”.

As the value used for determining the difference in frequency between the pulse signal and the clock signal CLK, “1” may be used in place of “2”. In this case, a control of increasing a pulse width of a pulse signal is performed when frequency of the pulse signal within a predetermined time is higher than frequency of a clock signal CLK within the predetermined time by 1 or more, that is, when the frequency of the pulse signal is higher than the frequency of the clock signal CLK. On the other hand, steps of the control for decreasing a pulse width of a pulse signal are performed when the frequency of the pulse signal within a predetermined time is lower than the frequency of the clock signal CLK by “1” or more, that is, when the frequency of the pulse signal is lower than the frequency of the clock signal CLK. When both frequencies are equal, control steps of maintaining the pulse width of the pulse signal may be performed. That is, it is possible to perform a control of making frequency of a pulse signal in the pulse forming circuit 11 coincide with frequency of a clock signal CLK.

The pulse forming circuit 11 may be configured such that a pulse generating circuit which outputs a pulse at an H level (or an L level) until a count value reaches a predetermined count value is used, and setting of such a count value is changed in response to an instruction signal from a FLL circuit 12 thus forming a pulse signal having an adjusted pulse width.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A power source circuit comprising:
a first power source terminal to which a DC input voltage is applied;
a second power source terminal to which a reference voltage is applied;
an output terminal to which an output voltage is supplied;
a first switching transistor that is connected between the first power source terminal and the output terminal;
a comparator configured to compare a feedback voltage of the output voltage with a predetermined reference voltage;
a pulse forming circuit configured to form a pulse signal having a predetermined width in accordance with an output from the comparator;
a timing adjustment circuit to which the pulse signal is supplied and configured to output a control signal for the first switching transistor according to a pulse width of the pulse signal; and
a frequency-locked loop (FLL) circuit to which a reference frequency signal and a pulse signal of the pulse forming circuit are supplied, the FLL circuit being configured to control the pulse width of the pulse signal of the pulse forming circuit in accordance with a frequency of the reference frequency signal and a frequency of the pulse signal.

2. The circuit according to claim 1, wherein
the FLL circuit includes a comparator configured to compare the frequency of the reference frequency signal and the frequency of the pulse signal of the pulse forming circuit, and is configured to control the pulse forming circuit to adjust the pulse width of the pulse signal according to the comparison result.

3. The circuit according to claim 2, wherein
the FLL circuit controls the pulse forming circuit to increase the pulse width if the frequency of the reference frequency signal is less than the frequency of the pulse signal and to decrease the pulse width if the frequency of the reference frequency signal is greater than the frequency of the pulse signal.

4. The circuit according to claim 2, wherein
the pulse width of the pulse signal is changed with a set width each time the FLL controls the pulse forming circuit to adjust the pulse width.

5. The circuit according to claim 1, wherein
the FLL circuit includes a first counter that increments at a frequency of the reference frequency signal, a second counter that increments at a frequency of the pulse signal, and a comparator configured to compare values of the first and second counters, and is configured to control the pulse forming circuit to adjust the pulse width of the pulse signal according to the comparison result.

6. The circuit according to claim 5, wherein
the FLL circuit controls the pulse forming circuit to increase the pulse width if the first counter value is less than the second counter value and to decrease the pulse width if the first counter value is greater than the second counter value.

7. The circuit according to claim 5, wherein
the FLL circuit controls the pulse forming circuit to increase the pulse width if the first counter value is less than the second counter value by 2 or more, to decrease the pulse width if the first counter value is greater than the second counter value by 2 or more, and otherwise to maintain the pulse width.

8. The circuit according to claim 5, wherein
the pulse width of the pulse signal is changed with a set width each time the FLL controls the pulse forming circuit to adjust the pulse width.

9. The circuit according to claim 1, wherein the pulse forming circuit outputs the pulse signal when a feedback voltage of the output voltage becomes lower than the reference voltage.

10. The circuit according to claim 1, further comprising:
a second switching transistor connected between the output terminal and the second power source terminal, wherein the second switching transistor is turned on and off in a complementary manner with respect to the first switching transistor.

11. A method performing constant-ON time control in a power source circuit including a first power source terminal to which a DC input voltage is applied, a second power source terminal to which a reference voltage is applied, an output terminal to which an output voltage is supplied, and a first switching transistor that is connected between the first power source terminal and the output terminal, comprising:
comparing a feedback voltage of the output voltage with a predetermined reference voltage;
forming a pulse signal having a predetermined width in accordance with an output from the comparator and outputting the pulse signal based on said comparing;
generating a control signal for the first switching transistor according to a pulse width of the output pulse signal; and
adjusting the pulse width of the output pulse signal in accordance with a frequency of the reference frequency signal and a frequency of the output pulse signal.

12. The method according to claim 11, further comprising:
comparing the frequency of the reference frequency signal and the frequency of the output pulse signal of the pulse forming circuit, wherein
the pulse width of the output pulse signal is adjusted according to the comparison result.

13. The method according to claim 12, wherein
the pulse width is increased if the frequency of the reference frequency signal is less than the frequency of the output pulse signal and decreased if the frequency of the reference frequency signal is greater than the frequency of the output pulse signal.

14. The method according to claim 12, wherein
the pulse width of the output pulse signal is changed with a set width each time the comparison result is generated.

15. The method according to claim 11, further comprising:
incrementing a first counter at a frequency of the reference frequency signal, and a second counter at a frequency of the output pulse signal; and
comparing values of the first and second counters, wherein
the pulse width of the output pulse signal is adjusted according to the comparison result.

16. The method according to claim 15, wherein
the pulse width is increased if the first counter value is less than the second counter value and is decreased if the first counter value is greater than the second counter value.

17. The method according to claim 15, wherein
the pulse width is increased if the first counter value is less than the second counter value by 2 or more, decreased if the first counter value is greater than the second counter value by 2 or more, and maintained otherwise.

18. The method according to claim 15, wherein
the pulse width of the output pulse signal is changed with a set width each time the pulse width is adjusted as a result of the comparison result.

19. The method according to claim 11, wherein
the pulse signal is output when a feedback voltage of the output voltage becomes lower than the reference voltage.

20. The method according to claim 11, wherein the power source circuit further comprises a second switching transistor connected between the output terminal and the second power source terminal, and further comprising:
controlling the second switching transistor in a complementary manner with respect to the first switching transistor.
